(19) United States
(12) Patent Application Publication
(10) Pub. No.: US 2025/0023796 A1
(43) Pub. Date: Jan. 16, 2025

(54) NETWORK DEVICE MANAGEMENT METHOD, NETWORK DEVICE AND STORAGE MEDIUM

(71) Applicant: RUIJIE NETWORKS CO., LTD., Fujian (CN)

(72) Inventor: Shuai GU, Fujian (CN)

(73) Assignee: RUIJIE NETWORKS CO., LTD., Fujian (CN)

(21) Appl. No.: 18/896,968

(22) Filed: Sep. 26, 2024

Related U.S. Application Data
(63) Continuation of application No. PCT/CN2023/142113, filed on Dec. 26, 2023.

(30) Foreign Application Priority Data
Dec. 27, 2022 (CN) 202211683576.3

(51) Int. Cl. H04L 41/22; H04L 61/103; H04L 61/59

(52) U.S. Cl. CPC H04L 41/22; H04L 61/103; H04L 61/59

(57) ABSTRACT

This application discloses a network device management method and a network device and a storage medium. The method includes: displaying a management page and a device list of the network device in response to a received display request, where the management page includes management information for managing a corresponding network device, the device list includes a link control for at least one other network device that is in a same network device cluster as the network device, and the link control for the other network device corresponds to the other network device; determining the other network device corresponding to the management page view request; and obtaining a management page corresponding to the other network device through the link control corresponding to the other network device, and nesting and displaying the management page in the management page corresponding to the network device.

### CROSS-REFERENCE TO RELATED APPLICATIONS

This application is a continuation of PCT application No. PCT/CN2023/142113, filed on Dec. 26, 2023 and entitled “Network device management method and apparatus, and storage medium”, which claims priority to Chinese Patent Application No. 202211683576.3, filed with the China National Intellectual Property Administration on Dec. 27, 2022 and entitled “NETWORK DEVICE MANAGEMENT METHOD AND APPARATUS AND STORAGE MEDIUM”, both of which is incorporated herein by reference in their entireties.

### TECHNICAL FIELD

This application relates to the field of network management technologies, and in particular to a network device management method, a network device and a storage medium.

### BACKGROUND

A network device cluster usually includes a plurality of network devices, and each network device runs one web server. Each web server can generate a web management page in the corresponding network device to respond to control instructions.

### SUMMARY

Embodiments of this application provide a network device management method and apparatus and a storage medium.

According to a first aspect, an embodiment of this application provides a network device management method, applied to a network device and including:
displaying a management page and a device list of the network device in response to a received display request, where the management page includes management information for managing a corresponding network device, the device list includes a link control for at least one other network device that is in a same network device cluster as the network device, and the link control for the other network device corresponds to the other network device;
determining, in response to a management page view request received through the device list, the other network device corresponding to the management page view request; and
obtaining a management page corresponding to the other network device through the link control corresponding to the other network device, and displaying the management page corresponding to the other network device with nesting the management page corresponding to the other network device into the management page corresponding to the network device.

Optionally, the network device and the other network device are connected through an IP address or a MAC address of the other network device.

Optionally, when the link control is created based on the IP address of the corresponding other network device, the network device and the other network device are connected through the IP address of the other network device; or
when the link control is created based on the MAC address of the corresponding other network device, the network device and the other network device are connected through the MAC address of the other network device; or
when the link control is created based on both the IP address and the MAC address of the corresponding other network device, the network device and the other network device are connected through the IP address or the MAC address of the other network device.

Optionally, a quantity of other network devices is plurality, and the management page of the network device includes management information for managing a corresponding network device, which is management information of the network device, or management information of a designated network device in the network device cluster, where the designated network device is a network device designated in advance in the other network devices.

Optionally, when the management information included in the management page of the network device is the management information of the designated network device, the management information corresponding to the network device is displayed in the management page of the network device by integrating the management information corresponding to the network device.

Optionally, when the management information included in the management page of the network device is the management information of the designated network device, the management information corresponding to the network device is obtained and displayed through a link control corresponding to the network device.

Optionally, identification information is pre-configured in the link control.

Optionally, the obtaining a management page corresponding to the other network device through the link control corresponding to the other network device includes:
proxying, based on the identification information pre-configured in the link control, the management page view request to the other network device corresponding to the link control.

Optionally, each network device in the same network device cluster is pre-configured with a first communication protocol, and shares client information based on the first communication protocol.

Optionally, the obtaining a management page corresponding to the other network device through the link control corresponding to the other network device includes:
obtaining, through the link control corresponding to the other network device, a management page corresponding to the other network device from the other network device corresponding to the link control.

Optionally, a quantity of other network devices is plurality, and the obtaining a management page corresponding to the other network device through the link control corresponding to the other network device includes:
obtaining, through the link control corresponding to the other network device, a management page corresponding to the other network device corresponding to the link control from a designated network device in the same network device cluster, where the designated network device is a network device designated in advance in the other network devices.

Optionally, the device list is generated in the following ways:
determining an IP address and/or a MAC address of the other network devices connected to the network device, respectively; and
creating a link control based on the IP address and/or MAC address, respectively, and generating the device list based on the link control.

Optionally, the displaying the management page corresponding to the other network device with nesting the management page corresponding to the other network device into the management page corresponding to the network device includes:
nesting the management page corresponding to the other network device into a pop-up window; and
setting a page style in the pop-up window based on a preset display mode and displaying the set pop-up window;
where the display mode includes a primary display mode and a secondary display mode, a page style set for the primary display mode is determined based on a style parameter pre-configured in the network device, and a page style set for the secondary display mode is determined based on a style parameter pre-configured in the other network device.

Optionally, after the nesting and displaying the management page in the first management page, the method further includes:
managing the other network device in response to a management request triggered by a client through the management page corresponding to the other network device.

According to a second aspect, an embodiment of this application provides a network device management method applied to an other network device, where the method includes:
displaying a management page of the other network device and a device list in response to a received display request, where the management page includes management information for managing a corresponding other network device, the device list includes a link control for at least one network device that is in a same network device cluster as the other network device, and the link control for the network device corresponds to the network device;
determining, in response to a management page view request received through the device list, the network device corresponding to the management page view request; and
obtaining a management page corresponding to the network device through the link control corresponding to the network device, and nesting and displaying the management page corresponding to the network device in the management page corresponding to the other network device.

Optionally, when the link control is created based on an IP address of the corresponding network device, the other network device and the network device are connected through the IP address of the network device; or
when the link control is created based on a MAC address of the corresponding network device, the other network device and the network device are connected through the MAC address of the network device; or
when the link control is created based on both the IP address and the MAC address of the corresponding network device, the other network device and the network device are connected through the IP address or the MAC address of the network device.

Optionally, a quantity of another network devices is plurality, and the management page of the other network device includes management information for managing a corresponding other network device, which is management information of the other network device, or management information of a designated network device in the cluster, where the designated network device is a network device designated in advance in the other network devices.

Optionally, a quantity of other network devices is plurality, and the obtaining a management page corresponding to the network device through the link control corresponding to the network device includes:

obtaining, through the link control corresponding to the network device, a management page corresponding to the network device from the network device corresponding to the link control; or
obtaining, through the link control corresponding to the network device, a management page corresponding to the network device corresponding to the link control from a designated network device in the network device cluster, where the designated network device is a network device designated in advance in the other network devices.

Optionally, the device list is generated in the following ways:
determining an IP address and/or a MAC address of the at least one network device connected to the other network device, respectively; and
creating a link control based on the IP address and/or MAC address, respectively, and generating the device list based on the link control.

Optionally, the nesting and displaying the management page corresponding to the network device in the management page corresponding to the other network device includes:
nesting the management page corresponding to the network device into a pop-up window; and
setting a page style in the pop-up window based on a preset display mode and displaying the set pop-up window;
where the display mode includes a primary display mode and a secondary display mode, a page style set for the primary display mode is determined based on a style parameter pre-configured in the other network device, and a page style set for the secondary display mode is determined based on a style parameter pre-configured in the network device.

Optionally, after the nesting and displaying the management page in the first management page, the method further includes:
managing the network device in response to a management request triggered through the management page corresponding to the network device.

According to a third aspect, an embodiment of this application further provides a network device management apparatus, including:
a first display module, configured to display a management page and a device list of the network device in response to a received display request, where the management page includes management information for managing a corresponding network device, the device list includes a link control for at least one other network device that is in a same network device cluster as the network device, and the link control for the other network device corresponds to the other network device;
a determining module, configured to determine, in response to a management page view request received through the device list, the other network device corresponding to the management page view request; and
a second display module, configured to: obtain a management page corresponding to the other network device through the link control corresponding to the other network device, and display the management page corresponding to the other network device with nesting the management page corresponding to the other network device into the management page corresponding to the network device.

Optionally, when the link control is created based on the IP address of the corresponding other network device, the network device and the other network device are connected through the IP address of the other network device; or
when the link control is created based on the MAC address of the corresponding other network device, the network device and the other network device are connected through the MAC address of the other network device; or
when the link control is created based on both the IP address and the MAC address of the corresponding other network device, the network device and the other network device are connected through the IP address or the MAC address of the other network device.

Optionally, a quantity of other network devices is plurality, and the management page of the network device includes management information for managing a corresponding network device, which is management information of the network device, or management information of a designated network device in the network device cluster, where the designated network device is a network device designated in advance in the other network devices.

Optionally, in the obtaining a management page corresponding to the other network device through the link control corresponding to the other network device, the second display module is configured to:
obtain, through the link control corresponding to the other network device, a management page corresponding to the other network device from the other network device corresponding to the link control; or
obtain, through the link control corresponding to the other network device, a management page corresponding to the other network device corresponding to the link control from a designated network device in the network device cluster.

Optionally, the device list is generated in the following ways:
determining an IP address and/or a MAC address of the at least one other network device connected to the network device, respectively; and
creating a link control based on the IP address and/or MAC address, respectively, and generating the device list based on the link control.

Optionally, in the displaying the management page corresponding to the other network device with nesting the management page corresponding to the other network device into the management page corresponding to the network device, the second display module is further configured to:
nest the management page corresponding to the other network device into a pop-up window; and
set a page style in the pop-up window based on a preset display mode and display the set pop-up window;
where the display mode includes a primary display mode and a secondary display mode, a page style set for the primary display mode is determined based on a style parameter pre-configured in the network device, and a page style set for the secondary display mode is determined based on a style parameter pre-configured in the other network device.

Optionally, after the nesting and displaying the management page in a first management page, the apparatus further includes a management module, where the management module is configured to:
manage the other network device in response to a management request triggered by a client through the management page corresponding to the other network device.

According to a fourth aspect, a network device is provided, including:
a memory, configured to store an executable instruction; and
a processor, configured to read and execute the executable instruction stored in the memory to implement the method according to any one of the first aspect.

According to a fifth aspect, a computer-readable storage medium is provided, where when an instruction in the storage medium is executed by a processor, the processor is enabled to perform the method according to any one of the first aspect. According to the embodiments of this application, an electronic device is further provided, where the electronic device includes a processor, a communication interface, a memory, and a communication bus, and the processor, the communication interface, and the memory communicate with each other through the communication bus;
the memory is configured to store a computer program; and
the processor is configured to implement the foregoing method steps when executing the program stored in the memory.

According to an embodiment of this application, a computer-readable storage medium is further provided, where the computer-readable storage medium stores a computer program, and the foregoing method steps are implemented when the computer program is executed by a processor.

In the network device management method and apparatus and the storage medium provided in the embodiments of this application, the method is applied to a network device and includes: displaying a management page and a device list of the network device in response to a received display request, where the management page includes management information for managing a corresponding network device, the device list includes a link control for at least one other network device that is in a same network device cluster as the network device, and the link control for the other network device corresponds to the other network device; determining, in response to a management page view request received through the device list, the other network device corresponding to the management page view request; and obtaining a management page corresponding to the other network device through the link control corresponding to the other network device, and nesting and displaying the management page in the management page corresponding to the network device. In this way, the management page corresponding to the other network device may be displayed in the management page corresponding to the network device, and the management page of the network device may be easily and quickly obtained and displayed in real time.

Other features and advantages of this application will be set forth later in the specification, and in part will be readily apparent from the specification, or may be understood by implementing this application. Objectives and other advantages of this application may be achieved and obtained by using a structure particularly stated in the written specification, claims, and accompanying drawings.

### BRIEF DESCRIPTION OF DRAWINGS

To describe the technical solutions in the embodiments of this application more clearly, the following briefly describes the accompanying drawings required for describing the embodiments. Apparently, the accompanying drawings in the following description show merely some embodiments of this application, and a person of ordinary skill in the art may derive drawings of other embodiments from these accompanying drawings without creative efforts.

The accompanying drawings described herein are intended for better understanding of this application, and constitute a part of this application. Exemplary embodiments and descriptions thereof in this application are intended to interpret this application and do not constitute any improper limitation on this application.

FIG. 1 is a schematic diagram of a system architecture for displaying a management page according to an embodiment of this application.

FIG. 2 is a schematic diagram of a process for displaying a management page according to an embodiment of this application.

FIG. 3 is a schematic diagram of a process for nesting and displaying a management page according to an embodiment of this application.

FIG. 4 is a schematic diagram of a process of management based on a management page according to an embodiment of this application.

FIG. 5 is a schematic diagram of a logical architecture of a network device management apparatus according to an embodiment of this application.

FIG. 6 is a schematic diagram of a logical architecture of other network device management apparatus according to an embodiment of this application.

FIG. 7 is a schematic diagram of a physical architecture of a network device according to an embodiment of this application.

### DESCRIPTION OF EMBODIMENTS

To make the objectives, technical solutions, and advantages of the embodiments of this application clearer, the following clearly and thoroughly describes the technical solutions of this application with reference to the accompanying drawings in the embodiments of this application. Apparently, the described embodiments are some but not all of the embodiments of this application. All other embodiments obtained by a person of ordinary skill in the art based on the embodiments described in this application document without creative efforts shall fall within the protection scope of the technical solutions of this application.

In the specification, claims, and accompanying drawings of this application, the terms “first” and “second” are used to distinguish between different objects, and not intended to describe a specific order. In addition, the term “include” and any other variant thereof are intended to cover non-exclusive protection. For example, a process, method, system, product, or device that includes a series of steps or units is not limited to the listed steps or units, but optionally further includes a step or unit unlisted, or optionally further includes another inherent step or unit of the process, method, product, or device. The term “a plurality of” in this application may mean at least two, for example, two, three, or more. However, the embodiments of this application are not limited thereto.

In addition, the term “and/or” in this specification describes only an association relationship for describing associated objects and represents that three relationships may exist. For example, A and/or B may represent the following three cases: Only A exists, both A and B exist, and only B exists. In addition, unless otherwise specified, the character “/” in this specification usually indicates an “or” relationship between associated objects.

Currently, when a client accesses a network device cluster, there are two ways to obtain a web management page corresponding to each network device.

Way 1: The client logs in to different network devices separately, obtains corresponding web management pages and displays them respectively, and implements control over the network devices after receiving management instructions triggered for the web management pages. However, the foregoing process of obtaining web management pages is cumbersome and time-consuming.

Way 2: One of the network devices obtains web management pages of other network devices separately, integrates the foregoing content and then displays them separately, and implements control over the network devices after receiving management instructions triggered for the web management pages. However, the foregoing integration method needs to be determined in advance. When a web management page of a certain network device has a version to be upgraded, it cannot be automatically upgraded and displayed accordingly, and the web management page of the upgraded network device needs to be obtained again, operation steps of which are cumbersome.

The following describes the embodiments of this application in detail with reference to the accompanying drawings.

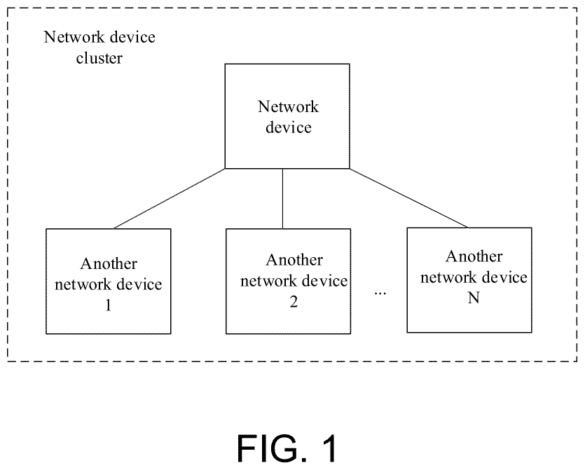

Referring to FIG. 1, in an embodiment of this application, a network device cluster includes at least one network device and at least one other network device connected to the network device. In FIG. 1, other network device 1, other network device 2, and other network device n are used as examples to represent the other network devices connected to the network device.

When a client accesses a network device in a network device cluster, the network device further accesses the other network device 1, 2, or n, and obtains a corresponding management page 1, a management page 2, . . . or a management page n, to nest and display them in a management page corresponding to the network device. This is described in detail below.

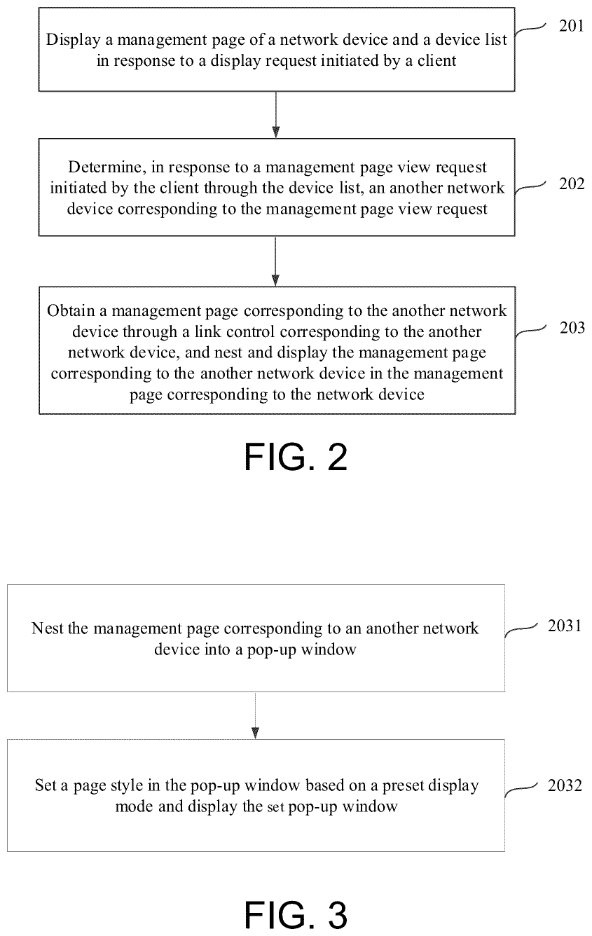

Referring to FIG. 2, in an embodiment of this application, a network device management method specifically includes the following steps.

Step 201: Display a management page of a network device and a device list in response to a display request sent by a client, where the management page includes management information for managing a corresponding network device, the device list includes a link control for at least one other network device that is in a same network device cluster as the network device, and the link control for the other network device corresponds to the other network device.

A user may obtain the management page of the corresponding other network device by triggering the link control. For example, when triggered, the link control can access the corresponding other network device through one of connection links and then obtain the management page of the other network device.

Considering that a protocol between network devices in the same network device cluster may be any public protocol or private protocol of layer 2 (Ethernet, for example, universal plug and play protocol and multicast DNS protocol) or layer 3 (Internet, for example, transparent inter-process communication protocol), a connection relationship between the network device and the other network device in the embodiments of this application is first introduced. In an exemplary embodiment, the connection relationship includes the following three cases.

Case 1: When the link control is created based on the IP address of the corresponding other network device, the network device and the other network device are connected through the IP address of the other network device.

In an embodiment of this application, the link control may be created based on the IP address of the corresponding other network device. In this case, the link control may be triggered to connect to the other network device, which is equivalent to accessing the other network device by triggering the IP address of the other network device. Then, the premise that the network device may be connected to the other network device by triggering the IP address of the other network device is that the network device and the other network device are connected through the IP address of the other network device, which means that a physical connection between the network device and the other network device is the IP address of the other network device. In this way, when triggered, the link control can access the corresponding other network device through the foregoing connection link.

Case 2: When the link control is created based on the MAC address of the corresponding other network device, the network device and the other network device are connected through the MAC address of the other network device.

In an embodiment of this application, the link control may be created based on the MAC address of the corresponding other network device. In this case, the link control may be triggered to connect to the other network device, which is equivalent to accessing the other network device by triggering the MAC address of the other network device. Then, the premise that the network device may be connected to the other network device by triggering the MAC address of the other network device is that the network device and the other network device are connected through the MAC address of the other network device, which means that a physical connection between the network device and the other network device is the MAC address of the other network device. In this way, when triggered, the link control can access the corresponding other network device through the foregoing connection link.

Case 3: When the link control is created based on both the IP address and the MAC address of the corresponding other network device, the network device and the other network device are connected through the IP address or the MAC address of the other network device. In an embodiment of this application, the link control may be created based on the IP address and MAC address of the corresponding other network device. In this case, the link control may be triggered to connect to the other network device, which is equivalent to accessing the other network device by triggering the IP address and MAC address of the other network device. Then, the premise that the network device can be connected to the corresponding other network device by triggering the IP address and MAC address of the other network device is that the network device and the other network device are connected through the IP address or the MAC address of the other network device, which means that a physical connection between the network device and the other network device is the IP address or the MAC address of the other network device. In this way, when triggered, the link control can access the corresponding other network device through one of connection links.

It should be noted that in the process of creating the link control, the correspondence between the link control and the IP address and/or MAC address needs to be determined in combination with the connection status between the network device and the other network device.

Additionally, in the process of creating the link control, a piece of identification information, which may be, for example, an identifier, is pre-configured in the link control. The identification information is used to represent that when the network device receives a management page view request of the other network device corresponding to a URL address of the link control accessed through the link control, the request is proxied to the other network device corresponding to the URL address, thereby realizing the access to the other network device. In this case, the network device providing the link control is a proxy server, and the other network device corresponding to the URL address corresponding to the link control is a target server, which means that a reverse proxy of the network device is implemented using the identification information.

In this way, provided that the network device is in the network device cluster, an identifier will be built in when the link control is created. Therefore, regardless of whether the network device is a new network device that is added into the cluster or a network device that is re-added into the cluster after exiting, it may automatically implement the reverse proxy through the link control, which increases the flexibility of network device management. In this embodiment, the management page and the device list of the network device may be displayed in response to the display request sent by a client.

In an embodiment of this application, after receiving the display request sent by the client, the network device parses the foregoing display request to determine a network device corresponding to the display request, and further obtains a management page of the network device corresponding to the display request.

It should be noted that the network device and the other network devices in the same network device cluster may all act as executing subjects of a network device management method.

In one embodiment, when a current device acting as the executing subject is the network device, after the network device responds to the display request of the client, a management page and a device list of the network device including link controls corresponding to the other network devices are displayed. In another embodiment, when a current device acting as the executing subject is the other network device, after the other network device responds to the display request of the client, a management page of the other network device and a device list including link controls corresponding to the network device and the rest of the other network devices are displayed.

The management page of the network device includes management information for managing a corresponding network device, which may be management information of the network device, or management information of a designated network device in the cluster.

The management page of the network device may usually include management information, which means that the operation and the like of the corresponding network device is managed through the management information. The management information may be the management information of the network device, which means that the network device is managed through the management page; or the management information may be the management information of the designated network device in the cluster, which means that a certain designated network device in the cluster except for the network device is managed through the management page, in other words, the same management page may be viewed by any network device in the network device cluster. The designated network device may be a network device configured and specified in advance. It should be noted that when the management page of the network device includes the management information of the designated network device, the management information of the network device in the management page corresponding to the network device may be directly displayed in the management page corresponding to the network device by integrating the management information corresponding to the network device, or may be obtained and displayed through the link control corresponding to the network device. In order to facilitate the management of the other network devices in the management page of the network device, in an embodiment of this application, the device list is also displayed when the management page of the network device is displayed.

In an embodiment of this application, in addition to basic information of each of the other network devices, the device list also includes link controls. The foregoing link control is a jump control for the network device to access the other network device. Specifically, it is necessary to first determine the other network device connected to the network device, and then obtain a corresponding IP address and/or MAC address of each of the other network devices, and create link controls based on the IP addresses and/or MAC addresses, respectively.

The following describes the generation method of the device list in detail, that is, the device list is generated in the following ways:

[1] Determine IP addresses and/or MAC addresses of the other network devices connected to the network device, respectively.

Considering that various network devices in the network device cluster are interconnected, after the network device responds to the display request sent by the client, the network device can be acted as a primary network device for interaction with the client. In this case, in order to facilitate the management of the other network devices, during implementation, the IP addresses and/or MAC addresses of the other network devices connected to the network device are further determined, in other words, connection links each from the network device to the respective one of the other network devices are determined.

[2] Create the link controls based on the IP addresses and/or MAC addresses, respectively, and generate the device list based on the link controls.

After the connection links are determined, the link controls are created based on the IP addresses and/or MAC addresses representing the connection links, respectively, and the created link controls are stored in the network device. Specifically, the device list is generated based on the various link controls. In this way, the network device can obtain the management page corresponding to the other connected network device according to the different link controls in the device list.

It should be noted that the specific display method of the device list in the management page can be flexibly set according to the usage scenario.

Step 202: Determine, in response to a management page view request sent by the client through the device list, the other network device corresponding to the management page view request.

During implementation, in addition to initiating a display request, the client may also initiates a management page view request for any another network device. The management page view request is generated by triggering any link control in the device list, which means that the management page view request is sent after the display request. The process of receiving the management page view request is similar to the process of receiving the display request, which will not be described in detail herein.

The management page view request, after received, is parsed to determine the other network device corresponding to the management page view request. Step 203: Obtain a management page corresponding to the other network device through the link control corresponding to the other network device, and display the management page corresponding to the other network device with nesting the management page corresponding to the other network device into the management page corresponding to the network device.

In this embodiment of this application, when the network device receives a management page view request entered by a user through the link control to access the other network device, the network device may determine, based on the identifier pre-configured by the link control, that the request needs to be proxied to the other network device corresponding to the URL address of the link control, which means that the network device acts as a proxy server in this case, and the other network device corresponding to the URL address of the link control is a target server. The management page corresponding to the other network device may be displayed on the network device.

Furthermore, in an embodiment, when the network device cluster is managed as an entire network, the network device may send a broadcast message through a pre-configured first communication protocol. In this way, when the other network devices are also pre-configured with the first communication protocol, they may recognize and respond to the broadcast message. Then, after mutual authentication based on the first communication protocol, the network devices may establish a connection and then form a network device cluster for entire network management.

Furthermore, each network device in the network device cluster may share client information based on the pre-configured first communication protocol. Specifically, the network devices may share client information, such as account and password information after mutual authentication based on the first communication protocol. In this way, when the network device receives an access request or management page view request entered by the client through the link control corresponding to the other network device, the network device proxies the access request or management page view request sent by the client to the corresponding other network device, without performing steps, such as client authentication or the like, operations of which are convenient and quick.

Considering that the connection relationship between network devices in the network device cluster is complex, the management page corresponding to the other network device may be stored in the other network device, or may be stored in any designated network device in the cluster, and the management page corresponding to the other network device is obtained through the link control corresponding to the other network device. The connection relationship may include the following cases.

Case (1): Obtain, through the link control corresponding to the other network device, a management page corresponding to the other network device from the other network device corresponding to the link control.

In one embodiment, the link control corresponding to the other network device is selected from the device list of the management page corresponding to the network device, and the management page corresponding to the other network device is obtained from the other network device (for example, a server of the other network device) through the selected link control corresponding to the other network device.

Alternatively, Case (2): Obtain, through the link control corresponding to the other network device, a management page corresponding to the other network device corresponding to the link control from a designated network device in the cluster.

In another embodiment, the link control corresponding to the other network device is selected from the device list of the management page corresponding to the network device, information of a designated network device in the cluster is determined through the selected link control, and then the management page corresponding to the other network device corresponding to the link control is obtained from the designated network device (for example, a management server corresponding to the other network device).

After the management page corresponding to the other network device is obtained, as shown in FIG. 3, the displaying the management page corresponding to the other network device with nesting the management page corresponding to the other network device into the management page corresponding to the network device specifically includes the following steps.

Step 2031: Nest the management page corresponding to the other network device into a pop-up window.

It should be noted herein that when the management page corresponding to the other network device needs to be displayed, the pop-up window floats in the management page corresponding to the network device, and when the management page corresponding to the other network device does not need to be displayed, the pop-up window may be hidden by operations, such as clicking or the like. The size and style of the pop-up window are not specifically limited herein. During implementation, each time a corresponding management page from an other network device is obtained, the management page may be completely nested inside the pop-up window, and the pop-up window is displayed in the management page corresponding to the network device according to the preset display mode.

Step 2032: Set a page style in the pop-up window based on a preset display mode and display the set pop-up window.

The display mode includes a primary display mode and a secondary display mode, where a page style set for the primary display mode is determined based on style parameters pre-configured in the network device, and a page style set for the secondary display mode is determined based on style parameters pre-configured in the other network device.

The management page corresponding to the network device is usually generated according to configuration of the network device, and the management page corresponding to the other network device displayed in the pop-up window is usually generated according to configuration of the other network device. Based on this, during implementation, the primary display mode is determined based on various style parameters pre-configured in the network device, and the secondary display mode is determined based on various style parameters pre-configured in the other network device. Therefore, the display mode of the management page in the pop-up window specifically includes the following three modes.

Mode (1): Determine the primary display mode as the display mode.

During implementation, the corresponding pre-configured various style parameters are obtained from the network device, then the primary display mode of the management page is determined, and the display mode of the management page nested in the pop-up window is set as the primary display mode. In this mode, the display of the management page is relatively unified. For example, when a color of a display border pre-set in the network device is red, it is determined that a color of a display border of the management page in the primary display mode is also red, and a color of a display border of the management page nested in the pop-up window is further set to red. In this way, the display mode of the management page in the pop-up window may be consistent with the display mode of the network device, and the display effect of the pop-up window may be unified with the network device.

Alternatively, Mode (2): Determine the secondary display mode as the display mode.

During implementation, the style parameters pre-configured in the other network device are obtained from the other network device, then the secondary display mode of the management page is determined, and the display mode of the management page nested in the pop-up window is set as the secondary display mode. In this mode, the management page may be displayed based on the setting of the other network device. In this way, the management pages of different network devices may be distinguished.

For example, when a color of a display border pre-set in the network device is red, it is determined that a color of a display border of the management page in the primary display mode is also red; and when a color of a display border pre-set in the other network device is blue, it is determined that a color of a display border in the secondary display mode of the management page is also blue, and a color of a display border of the management page nested in the pop-up window is further set to blue. In this way, the display mode of the management page in the pop-up window may be distinguished from the display mode of the network device, and the display effect of the pop-up window is more eye-catching.

Alternatively, Mode (3): Integrate the primary display mode and the secondary display mode, and determine the integrated display mode as the display mode.

During implementation, the foregoing primary display mode and secondary display mode are integrated, and the display mode of the management page nested in the pop-up window is set to the integrated display mode. In this mode, the management page corresponding to the network device and the management page corresponding to the other network device may be displayed in both uniformity and differentiation. The foregoing integration method includes, but is not limited to, the color of the management page displayed with reference to the primary display mode, the size of the border of the management page displayed with reference to the secondary display mode, and so on.

For example, when a color of a display border pre-set in the network device is red, it is determined that a color of a display border of the management page in the primary display mode is red; and when a color of a display border pre-set in the other network device is blue, it is determined that a color of a display border in the secondary display mode of the management page is blue, the primary display mode and the secondary display mode are further integrated, and the integrated display mode (for example, a color of an integrated display border is green) is determined as the display mode, that is, the display mode of the management page nested in the pop-up window is set to green. In this way, the display mode of the management page in the pop-up window may take into account the differences between the network device and the other network device.

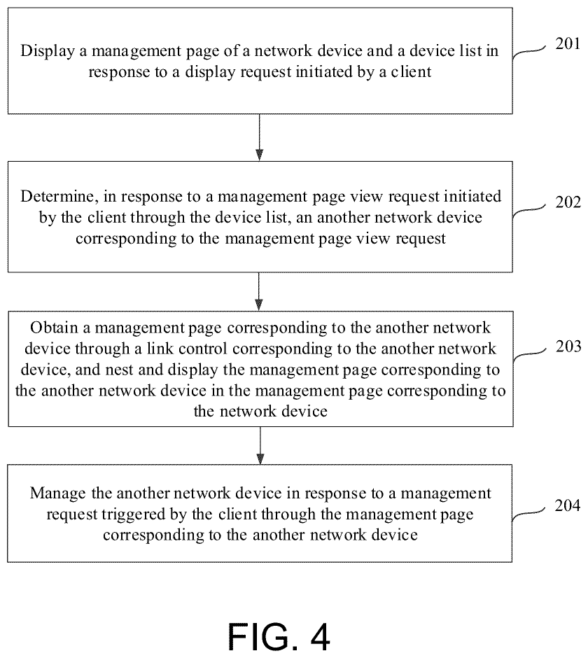

As shown in FIG. 4, it also should be noted that after the nesting and displaying the management page in a first management page, the method further includes the following step.

Step 204: Manage the other network device in response to a management request triggered by the client through the management page corresponding to the other network device.

During implementation, on the basis of displaying, through the device list, the management page corresponding to the other network device, it may also respond to the management request triggered by the client through the management page corresponding to the other network device. For example, when the client changes and configures the parameters of the other network device through the foregoing management page corresponding to the other network device, the network management device may respond to the management request and further manage the other network device, such as changing and configuring the parameters or the like.

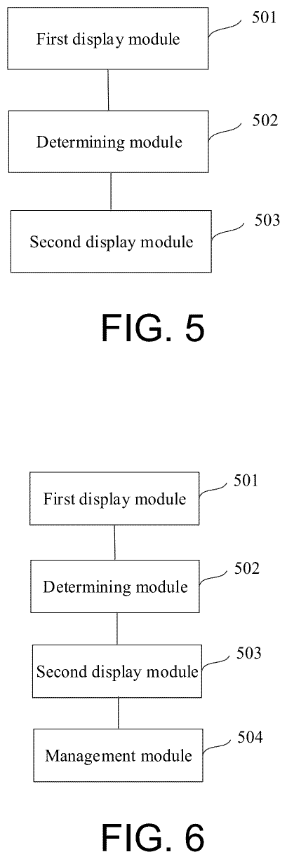

Based on the same inventive concept, referring to FIG. 5, an embodiment of this application provides a network device management apparatus, including:

a first display module 501, configured to display a management page and a device list of the network device in response to a display request sent by a client, where the management page includes management information for managing a corresponding network device, the device list includes a link control for at least one other network device that is in a same network device cluster as the network device, and the link control for the other network device corresponds to the other network device;

a determining module 502, configured to determine, in response to a management page view request sent by the client through the device list, the other network device corresponding to the management page view request; and a second display module 503, configured to: obtain a management page corresponding to the other network device through the link control corresponding to the other network device, and display the management page corresponding to the other network device with nesting the management page corresponding to the other network device into the management page corresponding to the network device.

Optionally, when the link control is created based on the IP address of the corresponding other network device, the network device and the other network device are connected through the IP address of the other network device; or when the link control is created based on the MAC address of the corresponding other network device, the network device and the other network device are connected through the MAC address of the other network device; or when the link control is created based on both the IP address and the MAC address of the corresponding other network device, the network device and the other network device are connected through the IP address or the MAC address of the other network device.

Optionally, the management information for managing a corresponding network device included in the management page of the network device is management information of the network device, or management information of a designated network device in the cluster.

Optionally, in the obtaining a management page corresponding to the other network device through the link control corresponding to the other network device, the second display module 503 is configured to:
obtain, through the link control corresponding to the other network device, a management page corresponding to the other network device from the other network device corresponding to the link control; or
obtain, through the link control corresponding to the other network device, a management page corresponding to the other network device corresponding to the link control from a designated network device in the cluster.

Optionally, the device list is generated in the following ways:
determining an IP address and/or a MAC address of the at least one other network device connected to the network device, respectively; and
creating a link control based on the IP address and/or MAC address, respectively, and generating the device list based on the link control.

Optionally, in the displaying the management page corresponding to the other network device with nesting the management page corresponding to the other network device into the management page corresponding to the network device, the second display module 503 is further configured to:
nest the management page corresponding to the other network device into a pop-up window; and
set a page style in the pop-up window based on a preset display mode and display the set pop-up window after.

The display mode includes a primary display mode and a secondary display mode, where a page style set for the primary display mode is determined based on style parameters pre-configured in the network device, and a page style set for the secondary display mode is determined based on style parameters pre-configured in the other network device.

Optionally, as shown in FIG. 6, after the nesting and displaying the management page in a first management page, the apparatus further includes a management module 504, where the management module is configured to:
manage the other network device in response to a management request triggered by a client through the management page corresponding to the other network device.

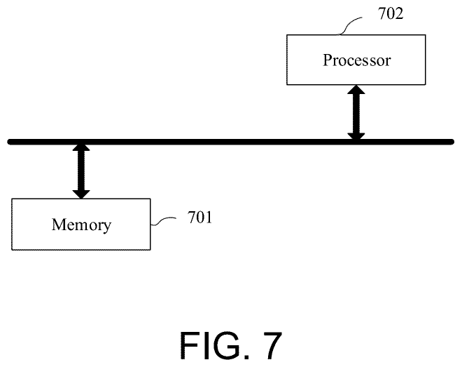

Based on the same inventive concept, referring to FIG. 7, an embodiment of this application provides a network device including: a memory 701, configured to store an executable instruction; and a processor 702, configured to read and execute the executable instruction stored in the memory, and perform the method according to any one of the first aspect.

The memory may include a Random Access Memory (RAM), or may include a Non-Volatile Memory (NVM), for example, at least one magnetic disk memory. Optionally, the memory may also be a storage apparatus located away from the processor.

The processor may be a general-purpose processor, including a Central Processing Unit (CPU), a Network Processor (NP), or the like; or may be a Digital Signal Processor (DSP), an Application-Specific Integrated Circuit (ASIC), a Field Programmable Gate Array (FPGA) or an other programmable logic device, a discrete gate or transistor logic device, or a discrete hardware component.

Based on the same inventive concept, an embodiment of this application provides a computer-readable storage medium, where when an instruction in the storage medium is executed by a processor, the processor is enabled to perform the method according to any one of the first aspect.

In conclusion, in the network device management method and apparatus and the storage medium provided in the embodiments of this application, the method is applied to a network device and includes: displaying a management page and a device list of the network device in response to a display request sent by a client, where the management page includes management information for managing a corresponding network device, the device list includes a link control for at least one other network device that is in a same network device cluster as the network device, and the link control for the other network device corresponds to the other network device; determining, in response to a management page view request sent by the client through the device list, the other network device corresponding to the management page view request; and obtaining a management page corresponding to the other network device through the link control corresponding to the other network device, and nesting and displaying the management page in the management page corresponding to the network device. In this way, the management page corresponding to the other network device may be displayed in the management page corresponding to the network device, which is convenient and quick.

This application is described with reference to the flowcharts and/or the block diagrams of the method, the device (system), and the computer program product according to the embodiments of this application. It should be understood that computer program instructions may be used to implement each procedure and/or each block in the flowcharts and/or the block diagrams and a combination of a procedure and/or a block in the flowcharts and/or the block diagrams. These computer program instructions may be provided to a general-purpose computer, a special-purpose computer, an embedded processor, or a processor of an other programmable data processing device to generate a machine, so that the instructions executed by the computer or the processor of the other programmable data processing device generate an apparatus for implementing a specific function in one or more processes in the flowcharts and/or one or more blocks in the block diagrams.

These computer program instructions may be stored in a computer-readable memory that may instruct the computer or the other programmable data processing device to work in a specific manner, so that the instructions stored in the computer-readable memory generate an artifact that includes an instruction apparatus. The instruction apparatus implements a specific function in one or more processes in the flowcharts and/or one or more blocks in the block diagrams.

These computer program instructions may also be loaded onto a computer or an other programmable data processing device, so that a series of operations and steps are performed on the computer or the other programmable device, thereby generating computer-implemented processing. Therefore, the instructions executed on the computer or the other programmable device provide steps for implementing a specific function in one or more processes in the flowcharts and/or one or more blocks in the block diagrams.

Although optional embodiments of this application have been described, persons skilled in the art may make additional changes and modifications to these embodiments once they learn the basic inventive concept. Therefore, the appended claims shall be construed to cover the optional embodiments and all changes and modifications falling within the scope of the embodiments of this application.

Apparently, a person skilled in the art may make various changes and variations to the embodiments of this application without departing from the spirit and scope of the embodiments of this application. Therefore, the embodiments of this application are also intended to cover the changes and variations provided that the changes and variations of this application fall within the scope of the claims of this application or equivalent technologies thereof.

What is claimed is:

1. A network device management method, applied to a network device and comprising:
displaying a management page and a device list of the network device in response to a received display request, wherein the management page comprises management information for managing a corresponding network device, the device list comprises a link control for at least one other network device that is in a same network device cluster as the network device, and the link control for the other network device corresponds to the other network device;
determining, in response to a management page view request received through the device list, the other network device corresponding to the management page view request; and
obtaining a management page corresponding to the other network device through the link control corresponding to the other network device, and displaying the management page corresponding to the other network device with nesting the management page corresponding to the other network device into the management page corresponding to the network device.

2. The method according to claim 1, wherein the network device and the other network device are connected through an IP address or a MAC address of the other network device.

3. The method according to claim 2, wherein when the link control is created based on the IP address of the corresponding other network device, the network device and the other network device are connected through the IP address of the other network device.

4. The method according to claim 2, wherein when the link control is created based on the MAC address of the corresponding other network device, the network device and the other network device are connected through the MAC address of the other network device.

5. The method according to claim 2, wherein when the link control is created based on both the IP address and the MAC address of the corresponding other network device, the network device and the other network device are connected through the IP address or the MAC address of the other network device.

6. The method according to claim 1, wherein a quantity of the other network device is plurality, and the management page of the network device comprises management information for managing a network device or management information of a designated network device in the same network device cluster, wherein the designated network device is a network device designated in advance in the other network devices.

7. The method according to claim 6, wherein when the management information comprised in the management page of the network device is the management information of the designated network device, the management information corresponding to the network device is displayed in the management page of the network device by integrating the management information corresponding to the network device.

8. The method according to claim 6, wherein when the management information comprised in the management page of the network device is the management information of the designated network device, the management information corresponding to the network device is obtained and displayed through a link control corresponding to the network device.

9. The method according to claim 1, wherein the obtaining the management page corresponding to the other network device through the link control corresponding to the other network device comprises:
accessing the other network device through the link control corresponding to the other network device; and
obtaining the management page corresponding to the other network device.

10. The method according to claim 1, wherein identification information is pre-configured in the link control.

11. The method according to claim 10, wherein the obtaining the management page corresponding to the other network device through the link control corresponding to the other network device comprises:
proxying, based on the identification information pre-configured in the link control, the management page view request to the other network device corresponding to the link control.

12. The method according to claim 1, wherein each network device in the same network device cluster is pre-configured with a first communication protocol, and shares client information based on the first communication protocol.

13. The method according to claim 1, wherein the obtaining the management page corresponding to the other network device through the link control corresponding to the other network device comprises:
obtaining, through the link control corresponding to the other network device, the management page corresponding to the other network device from the other network device corresponding to the link control.

14. The method according to claim 1, wherein a quantity of the other network device is plurality, and the obtaining the management page corresponding to the other network device through the link control corresponding to the other network device comprises:
obtaining, through the link control corresponding to the other network device, a management page corresponding to the other network device corresponding to the link control from a designated network device in the same network device cluster, wherein the designated network device is a network device designated in advance in the other network devices.

15. The method according to claim 1, wherein the device list is generated in the following ways:
determining an IP address and/or a MAC address of the other network device connected to the network device; and
creating a link control based on the IP address and/or MAC address, and generating the device list based on the link control.

16. The method according to claim 1, wherein the displaying the management page corresponding to the other network device with nesting the management page corresponding to the other network device into the management page corresponding to the network device comprises:
nesting the management page corresponding to the other network device into a pop-up window; and
setting a page style for the pop-up window based on a preset display mode and displaying the set pop-up window.

17. The method according to claim 16, wherein the display mode comprises a primary display mode and a secondary display mode, a page style set for the primary display mode is determined based on a style parameter pre-configured in the network device, and a page style set for the secondary display mode is determined based on a style parameter pre-configured in the other network device.

18. The method according to claim 1, wherein after the displaying the management page corresponding to the other network device with nesting the management page corresponding to the other network device into the management page corresponding to the network device, the method further comprises:
managing the other network device in response to a management request triggered through the management page corresponding to the other network device.

19. A network device, comprising:
a memory, configured to store an executable instruction; and
a processor, configured to read and execute the executable instruction stored in the memory to implement the method according to claim 1.

20. A non-transitory computer-readable storage medium, wherein when an instruction in the storage medium is executed by a processor, the processor is enabled to perform the method according to claim 1.
